(19) United States
(12) Patent Application Publication
(10) Pub. No.: US 2015/0167912 A1
(43) Pub. Date: Jun. 18, 2015

(54) HEAD LAMP FOR VEHICLE

(71) Applicant: SL CORPORATION, Daegu (KR)

(72) Inventors: Jong Ryoul Park, Gyungsan (KR); Jin Young Jung, Gyungsan (KR); Gi Man Park, Gyungsan (KR)

(21) Appl. No.: 14/572,147

(22) Filed: Dec. 16, 2014

(30) Foreign Application Priority Data
Dec. 17, 2013 (KR) 10-2013-0156903

(51) Int. Cl. F21S 8/10

(52) U.S. Cl. CPC F21S 48/1225; F21S 48/1388

(57) ABSTRACT

A head lamp for a vehicle includes a light source, a main lens refracting at least a portion of light emitted from the light source to irradiate a low beam or a high beam in front of the vehicle, a decoration lens surrounding the main lens in part or in whole and transmitting at least a portion of light emitted from the light source to form an optical image in the vicinity of the main lens, a main reflector reflecting at least a portion of light emitted from the light source toward the main lens, and a sub reflector provided abut to or near the main reflector and reflecting at least a portion of light emitted from the light source toward the decoration lens. The head lamp can improve overall aesthetic of vehicles equipped therewith.

### CROSS-REFERENCE TO RELATED APPLICATION

This application claims priority to Korean Patent Application No. 10-2013-0156903 filed on Dec. 17, 2013, which is herein incorporated by reference.

### TECHNICAL FIELD

The present invention relates to a head lamp for a vehicle that is mounted on a front surface of the vehicle.

### BACKGROUND

In general, a vehicle includes various vehicular lamps having an illumination function for easily verifying an object positioned around the vehicle and a signal function for notifying a driving state of the vehicle to drivers of other vehicles or road users.

In recent years, various car makers have expressed brand features of the car makers in respective components of the vehicle. Some car makers have expressed the brand features by a method of adding a function of expressing special images of the makers in a head lamp of the vehicle.

A head lamp decoration used at present is configured by a method of adding a separate decoration lamp module to the vicinity of a high beam module or a low beam module that radiates a high beam or a low beam.

However, adding a decoration lamp module in which a separate light source is consumed to the head lamp in the related art inevitably increases the size of the head lamp or downsizes the high beam module or the low beam module and as the decoration lamp module is added, manufacturing cost of the head lamp increases. Further, a separate light source is added, and as a result, a problem in which a power burden of a battery of the vehicle increases also occurs.

### SUMMARY

The present invention has been made in an effort to provide a head lamp for a vehicle that can secure a head lamp decoration function by using a light source that generates a low beam or a high beam without adding a separate light source for a head lamp decoration.

A head lamp for a vehicle according to an embodiment of the present invention comprises a light source, a main lens, a decoration lens, a main reflector, and a sub reflector. The main lens refracts at least a portion of light emitted from the light source to irradiate a low beam or a high beam in front of the vehicle. The decoration lens surrounds the main lens in part or in whole and transmitting at least a portion of light emitted from the light source to form an optical image in the vicinity of the main lens. The main reflector reflects at least a portion of light emitted from the light source toward the main lens. The sub reflector is provided abut to or near the main reflector and reflecting at least a portion of light emitted from the light source toward the decoration lens.

An optic corresponding to the optical image may be formed in the decoration lens. The optic may be formed on a rear surface of the decoration lens.

The main reflector may be formed by a curved panel opened toward the main lens and the sub reflector may suitably be provided abut to a top portion of the main reflector to reflect light toward the decoration lens. Alternatively, the sub reflector may be provided near a top portion of the main reflector to reflect light toward the decoration lens.

The main reflector may be formed by a curved panel opened toward the main lens and an opening groove may be formed on a top portion of the main reflector. The sub reflector may include a first sub reflector provided abut to or near a top portion of the opening groove and a second sub reflector provided abut to near the first sub reflector. The first sub reflector may reflect light toward the second sub reflector and the second sub reflector may reflect toward the decoration lens the light from the first sub reflector. The first sub reflector may extend from a top portion of the main reflector. The second sub reflector may be positioned behind the decoration lens.

A reflection surface of the sub reflector may be color-coated.

The decoration lens may be provided at each of left and right sides the main lens, the second sub reflector may be provided at each of left and right sides of the main reflector, and the first sub reflector may extend upwardly and symmetrically from the center of the opening groove.

The lamps according to the present invention provide many advantageous effects. For example, they can generate optical images by using a light source that generates the low beam or high beam without having to use a separate light source and without degrading lighting performance of the low beam or high beam. Since a separate light source is not used, overall energy efficiency of vehicles equipped therewith can be increased.

The technical objects of the present invention are not limited to the aforementioned technical objects, and other technical objects, which are not mentioned above, will be apparent to those skilled in the art from the following description.

### BRIEF DESCRIPTION OF THE DRAWINGS

The above and other features and advantages of the present invention will become more apparent by describing in detail embodiments thereof with reference to the attached drawings in which:

FIG. 1 is a perspective view of a head lamp for a vehicle according to an embodiment of the present invention;

FIG. 2 is a front view of a lens unit of the head lamp of FIG. 1;

FIG. 3 is a side view of the lens unit of FIG. 2;

FIG. 4 is a bottom view of the lens unit of FIG. 2;

FIG. 5 is a perspective view of reflectors of the head lamp of FIG. 1;

FIG. 6 illustrates a layout relationship of a light source, a shield, and reflectors of the head lamp of FIG. 1;

FIG. 7 is a diagram schematically illustrating an optical path of light emitted from a light source of the head lamp of FIG. 1; and

FIG. 8 is a diagram illustrating an optical image expressed in a decoration lens of the head lamp of FIG. 1.

### DETAILED DESCRIPTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, a head lamp for a vehicle according to an embodiment of the present invention will be described with reference to drawings.

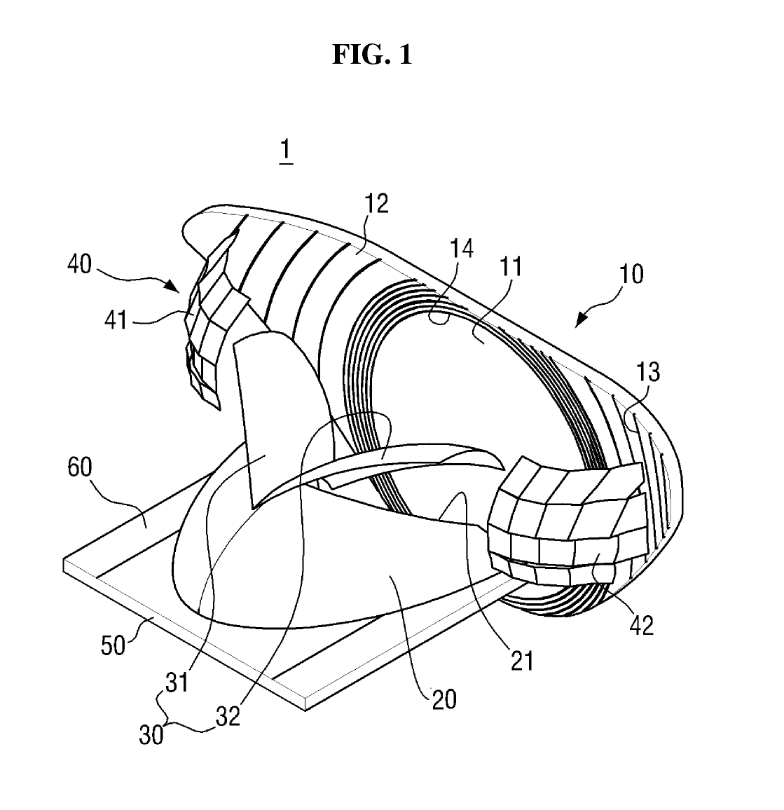

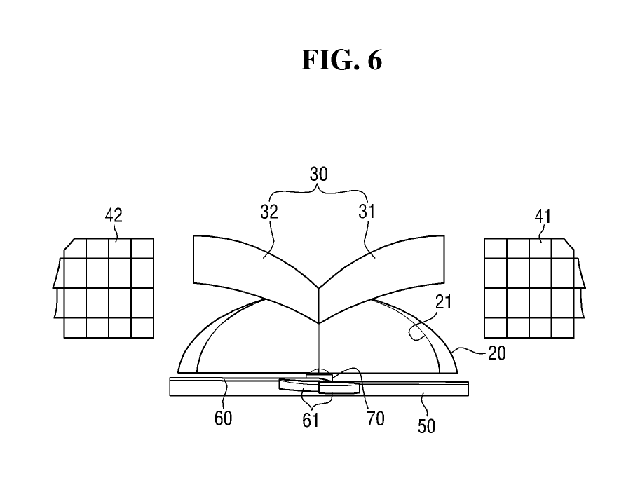

FIG. 1 illustrates a schematic configuration of a head lamp for a vehicle according to an embodiment of the present invention. As illustrated in FIG. 1, the head lamp 1 for a vehicle according to the embodiment of the present invention includes a lens unit 10, a main reflector 20, sub reflectors 30 and 40, a support plate 50, a shield 60, and a light source 70 (see FIG. 6).

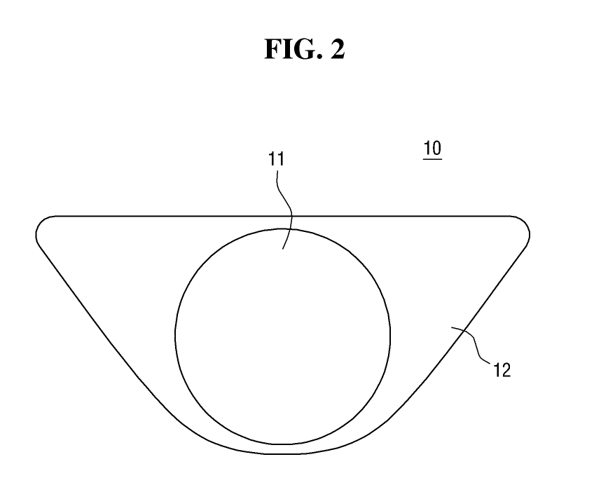

FIGS. 2, 3, and 4 are front, side, and bottom views of a lens unit of the head lamp of FIG. 1, respectively. The lens unit 10 includes a main lens 11 and a decoration lens 12. The main lens 11 is positioned at the center of the lens unit 10 and the decoration lens 12 is disposed to surround the main lens 11. The decoration lens 12 extends from the main lens 11 and may be formed integrally with the main lens 11.

The main lens 11 as a lens that radiates a low beam or a high beam to a front side of the vehicle may have a circular boundary as illustrated in FIG. 1 and the decoration lens 12 as a lens in which a decoration image is expressed may have a boundary having an approximately inverted triangular shape in which the low beam or the high beam is diffused to both sides of the main lens 11. The shapes of the main lens 11 and the decoration lens 12 illustrated in FIGS. 1 and 2 are non-limiting examples, and various designs and various designs may be adopted.

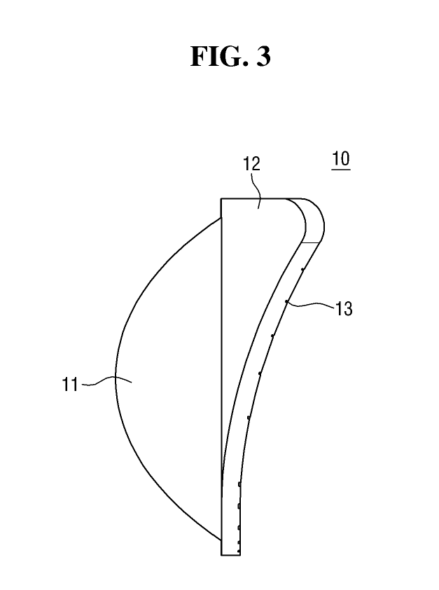

As illustrated in FIG. 3, the main lens 11 as a lens that radiates the low beam or high beam to a front side of the vehicle may adopt a spherical lens or an aspheric lens that is projected to be further convex to the front side than the decoration lens 12 in order to concentrate light in an optical pattern satisfying a visibility angle regulation of the low beam or high beam and radiate the concentrated light to the front side of the vehicle. The decoration image of the decoration lens 12 needs to be expressed without the need of concentrating lighting on the front side of the vehicle. The decoration lens 12 may be formed by a plane and/or a curve having an area corresponding to the decoration image.

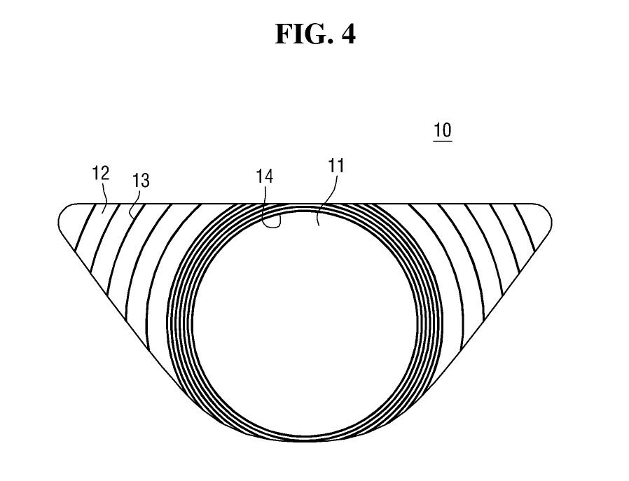

As illustrated in FIGS. 3 and 4, optics 13 and 14 corresponding to the decoration image to be expressed on the decoration lens 12 may be formed on a rear surface of the decoration lens 12. The optics 13 and 14 may be formed on a front surface of the decoration lens 12. Alternatively, they may be formed on the rear surface of the decoration lens 12. As illustrated in FIG. 3, the optics 13 and 14 may be recessed inside the decoration lens 12 or projected outside the decoration lens 12.

A non-limiting example of the first optic 14 is a plurality of circular optics formed in a region adjacent to the main lens 11 and having a small interval from each other while forming concentricity with the main lens 11. A non-limiting example of the second optic 13 is a plurality of curved optics forming the concentricity with the first optic 14 and having a larger interval from each other than the first optics 14 formed outside the first optic 14. Designs of the optics 13 and 14 illustrated in FIG. 4 are not limited thereto, and they may vary according to design or user needs.

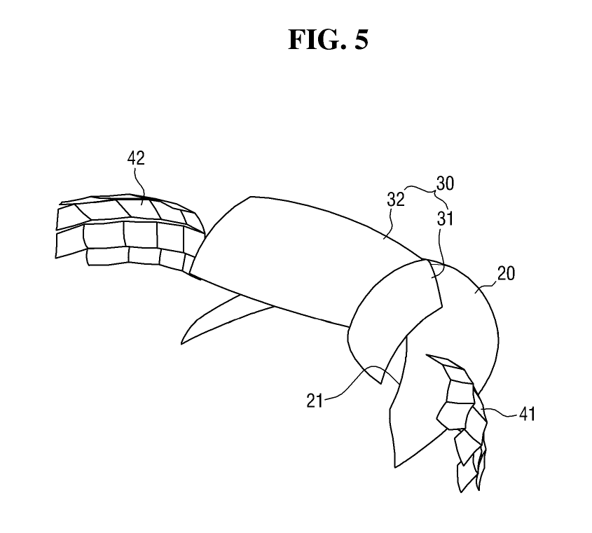

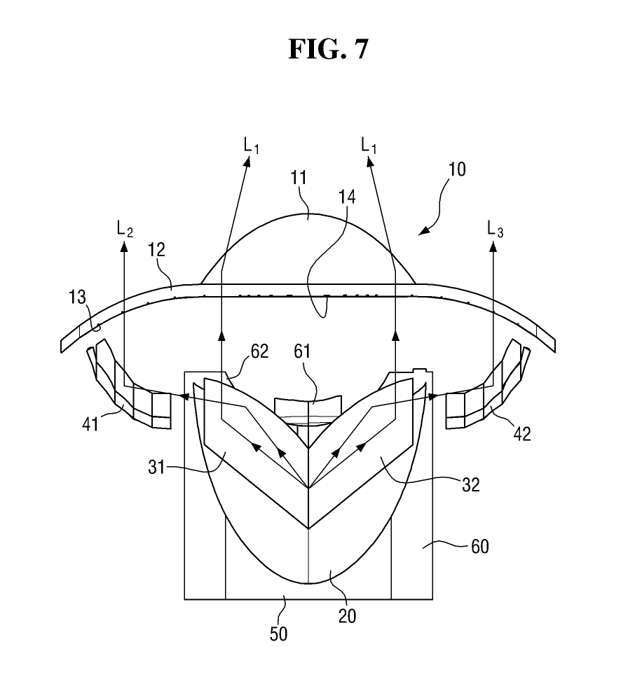

FIG. 5 is a perspective view of reflectors of the head lamp of FIG. 1. The reflectors include the main reflector 20 and the sub reflectors 30 and 40. As illustrated in FIG. 1, the main reflector 20 is provided in the rear side of the main lens 11. The main reflector 20 may be formed by an approximately semi-spherical curved panel opened toward the main lens 11. Further, an opening groove 21 which is recessed from the front side is formed on the top of the main reflector 20. A curved surface of the main reflector 20 may reflect light radiated from the light source 70 (see FIG. 6) to make a focus at a position adjacent to a cut-off plate 61 (see FIG. 7) of the shield 60 to be described below.

Meanwhile, the sub reflectors 30 and 40 include first sub reflectors 31 and 32 and second sub reflectors 41 and 42. The first sub reflectors 31 and 32 are positioned on the top of the opening groove 21 by extending from the top of the main reflector 20 or fixed to the top of the main reflector 20. The first sub reflectors 31 and 32 may include a pair of reflectors 31 and 32 and the pair of first sub reflectors 31 and 32 may extend to both sides toward the upper front side of the main reflector from the center of the opening groove 21 so as to be symmetric to each other around the light source 70 (see FIG. 6). The second sub reflectors 41 and 42 may include a pair of reflectors 41 and 42 and the pair of second sub reflectors 41 and 42 may be provided at both sides of the main reflector 20 so as to be positioned in the rear side of the decoration lens 12, respectively. As illustrated in FIGS. 1 and 5, the first sub reflectors 31 and 32 are formed in a shape to reflect some of light radiated from the light source 70 (see FIG. 6) toward the second sub reflectors 41 and 42 provided at both sides of the main reflector 20, respectively and the second sub reflectors 41 and 42 may be formed in a shape to reflect light incident from the first sub reflectors 31 and 32, respectively toward the decoration lens 12.

The main reflector 20, the first sub reflector 30, and the second sub reflectors 41 and 42 may be made of a material having high reflectivity or coated with a material having high reflectivity such as silver (Ag), or the like.

Meanwhile, the second sub reflectors 41 and 42 positioned in the rear side of the decoration lens 12 may be subjected to colored coating. This is to express a colored image on the decoration lens 12 by exposing colors of the second sub reflectors 41 and 42 to the outside through the decoration lens 12 while the light source is turned off. In case where only the optics 13 and 14 of the decoration lens 12 are formed to be transparent and residual parts are formed to be opaque, the decoration image may be expressed as a colored image while the light source is turned off.

FIG. 6 illustrates a layout relationship of the shield 60, the light source 70, and the reflectors 20, 30, 40 of the head lamp of FIG. 1. As illustrated in FIG. 6, the support plate 50 supports the light source 70 and the shield 60. The support plate 50 is a member of which one surface is flat and the shield 60 and the light source 70 are installed on one flat surface. In addition, the main reflector 20 may be installed on the support plate 50 so as to cover at least a part of each of the shield 60 and the light source 70. The light source 70 may be installed in such a manner that an optical axis of the light source 70 coincides with a central axis of the main reflector 20 so as to radiate emitted light upward. The shield 60 shields some of light that is emitted from the light source 70 and reflected by the main reflector 20, is radiated toward the main lens 11 to form a cut-off pattern of the low beam. To this end, the shield 60 may include a cut-off line 62 and a cut-off plate 61 which are recessed from the front side in order to cut off the light in the cut-off pattern. Therefore, the shield 60 may be used in a module in which the low beam is radiated through the main lens 11, but the shield 60 may not be used in a module in which the high beam is radiated.

Hereinafter, an operation of the head lamp 1 for a vehicle will be described with reference to FIG. 7.

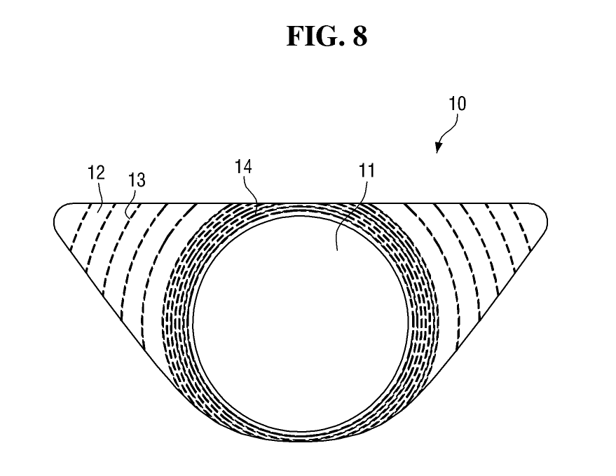

FIG. 7 is a diagram schematically illustrating an optical path of light emitted from a light source of the head lamp of FIG. 1, and FIG. 8 is a schematic diagram illustrating an optical image expressed in a decoration lens of the head lamp of FIG. 1. As illustrated in FIG. 7, some L1 of the light emitted from the light source 70 (see FIG. 6) is reflected by the main reflector 20 and passes through the main lens 11 to be radiated as the discharge low beam or high beam of the vehicle. When the shield 60 is present, some of the light is radiated as the low beam. When the shield 60 is not present, some of the light is radiated as the high beam. Meanwhile, as illustrated in FIG. 7, light L2 and L3 incident in the first sub reflectors 31 and 32 in light which is not incident into the main reflector 20 but lost among the light emitted from the light source 70 (see FIG. 6) is reflected on the second sub reflectors 41 and 42 by the first sub reflectors 31 and 32 and thereafter, radiated toward the decoration lens 12 by the second sub reflectors 41 and 42. Since the light L2 and L3 that passes through the decoration lens 12 forms an optical image corresponding to the shapes of the optics 13 and 14 in the decoration lens 12 by the optics 13 and 14, an optical image as illustrated in FIG. 8 may be observed outside the vehicle. Accordingly, the optical image is emitted to the vicinity of the main lens 11 as the decoration image under a night driving situation in which the vehicle is driven while radiating the low beam or high beam, and as a result, the aesthetic of the vehicle is improved. When the light source 70 (see FIG. 6) is turned off, colors coated on the second sub reflectors 41 and 42 are observed through the decoration lens 12 outside the vehicle, and as a result, the aesthetic of the vehicle is improved even in the daytime.

The head lamps according to the present invention provide advantages. For example, they can generate optical images by using a light source that generates the low beam or high beam without having to use a separate light source and without degrading lighting performance of the low beam or high beam. Since a separate light source is not used, overall energy efficiency of vehicles equipped therewith can be increased.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

1. A head lamp for a vehicle, comprising:
a light source;
a main lens refracting at least a portion of light emitted from the light source to irradiate a low beam or a high beam in front of the vehicle;
a decoration lens surrounding the main lens in part or in whole and transmitting at least a portion of light emitted from the light source to form an optical image in the vicinity of the main lens;
a main reflector reflecting at least a portion of light emitted from the light source toward the main lens; and
a sub reflector provided abut to or near the main reflector and reflecting at least a portion of light emitted from the light source toward the decoration lens.

2. The head lamp of claim 1, wherein an optic corresponding to the optical image is formed in the decoration lens.

3. The head lamp of claim 2, wherein the optic is formed on a rear surface of the decoration lens.

4. The head lamp of claim 1, wherein the main reflector is formed by a curved panel opened toward the main lens and the sub reflector is provided abut to a top portion of the main reflector to reflect light toward the decoration lens.

5. The head lamp of claim 1, wherein the main reflector is formed by a curved panel opened toward the main lens and the sub reflector is provided near a top portion of the main reflector to reflect light toward the decoration lens.

6. The head lamp of claim 1, wherein the main reflector is formed by a curved panel opened toward the main lens, and wherein
the sub reflector includes a first sub reflector provided abut to or near a top portion of the main reflector and a second sub reflector provided abut to near the first sub reflector, and the first sub reflector reflects light toward the second sub reflector and the second sub reflector reflects toward the decoration lens the light from the first sub reflector .

7. The head lamp of claim 6, wherein the first sub reflector extends from a top portion of the main reflector.

8. The head lamp of claim 6, wherein the second sub reflector is positioned behind the decoration lens.

9. The head lamp of claim 1, wherein a reflection surface of the sub reflector is color-coated.

10. The head lamp of claim 6, wherein the decoration lens is provided at each of left and right sides the main lens, the second sub reflector is provided at each of left and right sides of the main reflector, and the first sub reflector extends upwardly and symmetrically from the center of the main reflector.
